(19) United States
(12) Patent Application Publication
(10) Pub. No.: US 2010/0209049 A1
(43) Pub. Date: Aug. 19, 2010

(54) IMAGE PROFILE ANALYSIS (IPA) METHOD FOR PM FIBER ALIGNMENT

(75) Inventors: Wenxin Zheng, Moore, SC (US); Doug Duke, Simpsonville, SC (US); Toshiki Kubo, Greer, SC (US); Bryan Malinski, Simpsonville, SC (US)

Correspondence Address: SUGHRUE MION, PLLC, 2100 PENNSYLVANIA AVENUE, N.W., SUITE 800, WASHINGTON, DC, 20037, US

(73) Assignee: AFL TELECOMMUNICATIONS LLC, Spartanburg, SC (US)

(21) Appl. No.: 12/669,419

(22) PCT Filed: Oct. 1, 2009
(86) PCT No.: PCT/US09/59221

§ 371 Date: Apr. 7, 2010

Related U.S. Application Data
(60) Provisional application No. 61/101,852, filed on Oct. 1, 2008.

(51) Int. Cl. G02B 6/26; G06K 9/00; G01N 21/00

(52) U.S. Cl. 385/52; 382/100; 356/73.1

(57) ABSTRACT

A method of aligning a polarization-maintaining optical fiber by image profile analysis is provided. The method of aligning a polarization-maintaining optical fiber may include analyzing the polarization-maintaining optical fiber by illuminating a side of the optical fiber; rotating the optical fiber at incremental rotation angles; obtaining an image profile of the optical fiber at each rotation angle such that a focal plane of the image profile is positioned within the optical fiber; measuring an image parameter at each rotation angle based on the respective image profile; and constructing a measured image parameter profile of the optical fiber as a function of rotation angle based on the measured image parameters. The method may also include constructing an approximated image parameter profile of the optical fiber as a function of rotation angle by curve-fitting a mathematical function to the measured image parameter profile.

### CROSS-REFERENCE TO RELATED PATENT APPLICATION

This application claims the benefit of U.S. Provisional Application No. 61/101,852, filed on Oct. 1, 2008 in the United States Patent and Trademark Office, the disclosure of which is incorporated by reference in its entirety.

### BACKGROUND OF THE INVENTION

1. Field of the Invention

Methods consistent with the present invention relate to aligning a polarization-maintaining optical fiber, and more particularly, to aligning a polarization-maintaining optical fiber by image profile analysis.

2. Description of the Related Art

Polarization-maintaining optical fiber is a type of optical fiber in which the polarization of linearly-polarized light is maintained during propagation through the optical fiber. One type of polarization-maintaining optical fiber induces stress in the core by using a cladding with a non-circular cross-section or rods of another material within the cladding. For example, FIG. 1A shows a cross-section of a PANDA fiber, FIG. 1B shows a cross-section of an elliptical-clad fiber, and FIG. 1C shows a cross-section of a bow-tie fiber. Each of the optical fibers shown in FIGS. 1A-1C includes a stress-applying part (SAP) within the cladding. Another type of polarization-maintaining optical fiber uses the non-circular geometry of the core to maintain the polarization. For example, FIG. 2A shows a cross-section of an elliptic-core fiber produced by modified chemical vapor deposition (MCVD), and FIG. 2B shows a cross-section of an elliptic-core fiber produced by outside vapor deposition (OVD).

Polarization-maintaining optical fiber features two strongly maintained orthogonal polarization states or axes. Due to differences in the optical transmission properties of these two axes, the polarized light travels at a different velocity along each axis. Hence, one axes is referred to as the slow axis, and the other as the fast axis. The relationship of the slow and fast axes of the polarization maintaining fiber to the fiber structure and geometry is shown in FIGS. 3A-3D. In these figures the fast axis (50) and the slow axis (60) are identified. FIG. 3A shows the fast axis (50) and the slow axis (60) of a PANDA fiber. FIG. 3B shows the fast axis (50) and the slow axis (60) of an elliptical-clad fiber. FIG. 3C shows the fast axis (50) and the slow axis (60) of a bow-tie fiber. FIG. 3D shows the fast axis (50) and the slow axis (60) of an elliptical-core fiber. The ratio of the light power in the slow and fast axes of a polarization-maintaining optical fiber is known as the Polarization Extinction Ratio (PER). Two polarization-maintaining optical fibers that are imperfectly aligned to each other may have a rotational angle between the two polarization axes of the fibers. Therefore, some of the optical power in the preferred polarization axis (most commonly the slow axis) may be lost and cross over to the other polarization axis. This is known as polarization cross talk, and it can be calculated directly from the angular misalignment. The angular misalignment therefore changes and degrades the PER.

In order to align a polarization-maintaining optical fiber with another component, the polarization-maintaining optical fiber is rotated to a desired angle. For example, to maintain the polarization between two polarization-maintaining optical fibers of the same type, the angle (α) between the slow axes of the elliptical-clad fibers shown in FIG. 4 may be set to zero. On the other hand, to destroy the polarization between two polarization-maintaining optical fibers of the same type, the angle (α) between the slow axes of the elliptical-clad fibers shown in FIG. 4 may be set to 45°.

A related art manual method of aligning two polarization-maintaining optical fibers is shown in FIG. 5. In this manual method, light from a laser (100) is polarized by a first polarizer (105) and transmitted through two polarization-maintaining optical fibers (110). The emitted light is then transmitted through by a second polarizer (120) that has the same orientation as the first polarizer (105), and the amount of light is measured by the detector (125). The amount of measured light is maximized when the polarization directions of the two polarization-maintaining optical fibers (110) are aligned. For example, this may occur when the angle (α) between the axes of the elliptical-clad fibers shown in FIG. 4 is set to zero. A user manually rotates the polarization-maintaining optical fibers (110) with the rotators (115) until the amount of light measured by the detector (125) reaches a maximum. However, this manual alignment method has the disadvantages of being time-consuming and operator-dependent.

The basic measurement setup shown in FIG. 5 can also be utilized to measure the PER, and therefore can be employed at the time of fiber alignment and at any other time to confirm the quality of the alignment of two or more polarization-maintaining optical fibers, or polarization-maintaining devices or assemblies. Other measurement methods and systems may be utilized such as specialized PER meters, polarimeters, or polarization analyzers.

Another related art method of aligning polarization-maintaining optical fiber uses polarization observation by the lens effect (POL). As shown in FIG. 6, in the POL method, collimated light from a light source (150) is incident on the side of a polarization-maintaining optical fiber (160), and the intensity of the transmitted light at the focal plane (170) is recorded in an image. The polarization-maintaining optical fiber (160) acts as a cylindrical lens to focus the light at the focal plane (170). As shown in FIG. 7, an image recorded by the POL method has a bright line-shaped area surrounded by a dark area. As shown in FIG. 6, the resulting light intensity profile (180) of the POL image measured at the focal plane (170) has a maximum contrast (h). As shown in FIG. 8, when the polarization-maintaining optical fiber (160) is rotated, the height of the maximum contrast (h) changes because of the rotational asymmetry of the index of refraction.

FIG. 9A, FIG. 9B, and FIG. 9C show examples of contrast profiles measured by the POL method. FIG. 9A shows a POL contrast profile for a bow-tie fiber. FIG. 9B shows a POL contrast profile for a PANDA fiber. FIG. 9C shows a POL contrast profile for an elliptical-clad fiber.

A direct POL method can be used to align the polarization directions of two polarization-maintaining optical fibers. In the direct POL method, each polarization-maintaining optical fiber is rotated through an angular range, and the contrast (h) is recorded as a function of rotation angle for each polarization-maintaining optical fiber. The contrast measurements are then correlated with each other to determine the angular offset between the polarization-maintaining optical fibers. The angular offset is based on the location of the maximum correlation point. This angular offset is used to rotate one of the polarization-maintaining optical fibers with respect to the other polarization-maintaining optical fiber at a desired angle.

An indirect POL method can be used to align a polarization-maintaining optical fiber along a desired polarization direction. In the indirect POL method, the polarization-maintaining optical fiber is rotated through an angular range, and the contrast (h) is recorded as a function of rotation angle. A simulated contrast profile is then generated based on the known geometry of the polarization-maintaining optical fiber, and the measured contrast (h) is correlated with the simulated contrast profile to determine the angular orientation of the polarization-maintaining optical fiber. The angular orientation is based on the location of the maximum correlation point. Two polarization-maintaining optical fibers can be aligned by the indirect POL method by determining the angular orientation of each of the polarization-maintaining optical fibers and rotating one of the polarization-maintaining optical fibers to have a desired angle with respect to the other polarization-maintaining optical fiber.

One disadvantage of the POL method is that because the focal plane (170) is outside of the polarization-maintaining optical fiber (160), the POL method is limited to analyzing data from the exemplary contrast profiles illustrated in FIGS. 9A-9C, which are measured from images similar to the image shown in FIG. 7. More detailed data or the relation between other image factors and the fiber's rotational position cannot be discerned and analyzed. The POL contrast profile may not provide adequate data to enable alignment of some types of polarization maintaining fiber. Even if the POL contrast profile provides sufficient data for fiber alignment, the POL method may not provide sufficient accuracy for aligning the polarization-maintaining optical fiber.

Another related art method of aligning polarization-maintaining optical fiber uses a single image to align polarization-maintaining optical fibers. This alignment method is illustrated in FIG. 10, and is commonly known as the Profile Alignment System (PAS). As shown in FIG. 10, collimated light (200) from a light-emitting diode (LED) is incident on the side of the polarization-maintaining optical fiber (205), and the intensity of the transmitted light at the focal plane (210) is recorded in an image (as shown on the right-hand side of FIG. 10). The polarization-maintaining optical fiber (205) is then rotated until specific points (230) in the brightness intensity image profile (220) have approximately the same height. In the PAS method, the focal plane (210) is positioned within the polarization-maintaining optical fiber (205). Unlike the POL method, the PAS method does not utilize any measured or calculated relationship between fiber image features and the fiber rotational position. It simply rotates the fiber until the best symmetry between the peak heights of the specific points (230) in the brightness intensity image profile (220) has been achieved.

The PAS method may provide very precise alignment. However, the PAS method depends strongly on the structure of the polarization-maintaining optical fiber. The PAS method is limited to aligning polarization-maintaining optical fibers that have very distinct image profiles that exhibit symmetry from the center of the fiber when either the slow or fast axis of the fiber is observed in the plane of the camera. Fibers lacking this characteristic cannot be aligned by this method. Most PANDA fibers (such as the PANDA fiber shown in FIG. 10) and some bow-tie fibers may be aligned by this method. However, elliptical-core and elliptical SAP fibers cannot be aligned by this method, because they lack the required recognizable and symmetric pattern with specific points (230) that can be balanced when observed by this method.

Another related art method of aligning polarization-maintaining optical fiber uses an optical system that observes the ends of two polarization-maintaining optical fibers instead of observing an image from the side of the fiber as in the case of the POL and PAS methods. If a suitable optical system is constructed and the two polarization-maintaining optical fibers have already been cleaved prior to alignment and splicing, an end image of each fiber may be observed at the fiber orientation shown in FIGS. 1A-1C and FIGS. 2A-2B. Since the relationship of the fiber end view image and the slow and fast polarization axes is known as shown in FIGS. 3A-3D, the end view image of the two fibers may be utilized to align the two fibers to each other. As shown in FIG. 11, two opposed polarization-maintaining optical fibers (250, 260) are shown on either side of a double-faced reflective mirror (270). Each face of the mirror (270) reflects the end image of one of the polarization-maintaining optical fibers (250) (260) through the lens (280) and into the observation camera (290). This allows observation and analysis of the fiber structure. Rotational control is applied so the fibers may be aligned to each other at any desired relative angle. This method is commonly referred to as the end view method.

There are several problems with the end view method. One problem is that this method is very sensitive to the illumination applied to the polarization-maintaining optical fiber and to the characteristics of the fiber structure. For example, depending upon the composition of the fiber, the stress applying parts may or may not have adequate contrast relative to the fiber cladding. The combination of the illumination capabilities and the specific fiber characteristics may not allow alignment of some polarization-maintaining optical fibers. In other cases, if alignment is possible, the alignment accuracy may not be adequate or may be inferior to other methods. Furthermore, the presence of the mirror (270) between the ends of the optical fibers (250, 260) requires the mirror (270) to be placed on a translation stage mechanism so the mirror (270) can be moved out from between the two fibers (250, 260) before the two fibers (250, 260) are spliced together. Finally, once the two fibers (250, 260) are joined and spliced, it is no longer possible to insert the mirror (270). Therefore, it is not possible with this system to confirm the quality of post-splice alignment, or provide an accurate PER estimation based upon post-splice observation.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

Exemplary embodiments of the present invention provide a method of aligning a polarization-maintaining optical fiber.

According to an aspect of the present invention, there is provided a method of analyzing a polarization-maintaining optical fiber. The method includes illuminating a side of the optical fiber; rotating the optical fiber at incremental rotation angles; obtaining an image profile of the optical fiber at each rotation angle such that a focal plane of the image profile is positioned within the optical fiber; measuring an image parameter at each rotation angle based on the respective image profile; and constructing a measured image parameter profile of the optical fiber as a function of rotation angle based on the measured image parameters. The method may also include constructing an approximated image parameter profile of the optical fiber as a function of rotation angle by curve-fitting a mathematical function to the measured image parameter profile. The image parameter may be an upper ridge intensity difference, a lower ridge intensity difference, an upper valley intensity difference, a lower valley intensity difference, or a central peak intensity. The mathematical function may be a truncated Fourier series. The method may also include selecting a desired rotation angle based on the approximated image parameter profile and rotating the optical fiber to the desired rotation angle. The desired rotation angle may be along the slow axis or the fast axis of the optical fiber.

According to another aspect of the present invention, there is provided a method of aligning a polarization-maintaining optical fiber that includes illuminating a side of a reference optical fiber; rotating the reference optical fiber at incremental rotation angles; obtaining a reference image profile of the reference optical fiber at each rotation angle such that a focal plane of the reference image profile is positioned within the reference optical fiber; measuring an image parameter of the reference optical fiber at each rotation angle based on the respective reference image profile; constructing a measured image parameter profile of the reference optical fiber as a function of rotation angle based on the measured image parameters of the reference optical fiber; constructing an approximated image parameter profile of the reference optical fiber as a function of rotation angle by curve-fitting a mathematical function to the measured image parameter profile of the reference optical fiber; illuminating a side of the polarization-maintaining optical fiber; rotating the polarization-maintaining optical fiber at incremental rotation angles; obtaining an image profile of the polarization-maintaining optical fiber at each rotation angle such that a focal plane of the polarization-maintaining image profile is positioned within the polarization-maintaining optical fiber; measuring an image parameter of the polarization-maintaining optical fiber at each rotation angle based on the respective polarization-maintaining image profile; constructing a measured image parameter profile of the polarization-maintaining optical fiber as a function of rotation angle based on the measured image parameters of the polarization-maintaining optical fiber; calculating a correlation between the measured image parameter profile of the polarization-maintaining optical fiber and the approximated image parameter profile of the reference fiber; and rotating the polarization-maintaining optical fiber to a desired angle relative to the approximated image parameter profile of the reference optical fiber based on a maximum value of the correlation. The desired angle may be along the slow axis or the fast axis of the polarization-maintaining optical fiber.

According to another aspect of the present invention, there is provided a method of aligning a polarization-maintaining optical fiber that includes illuminating a side of a reference optical fiber; rotating the reference optical fiber at incremental rotation angles; obtaining a reference image profile of the reference optical fiber at each rotation angle such that a focal plane of the reference image profile is positioned within the reference optical fiber; measuring an image parameter of the reference optical fiber at each rotation angle based on the respective reference image profile; constructing a measured image parameter profile of the reference optical fiber as a function of rotation angle based on the measured image parameters of the reference optical fiber; illuminating a side of the polarization-maintaining optical fiber; rotating the polarization-maintaining optical fiber at incremental rotation angles; obtaining an image profile of the polarization-maintaining optical fiber at each rotation angle such that a focal plane of the polarization-maintaining image profile is positioned within the polarization-maintaining optical fiber; measuring an image parameter of the polarization-maintaining optical fiber at each rotation angle based on the respective polarization-maintaining image profile; constructing a measured image parameter profile of the polarization-maintaining optical fiber as a function of rotation angle based on the measured image parameters of the polarization-maintaining optical fiber; calculating a correlation between the measured image parameter profile of the polarization-maintaining optical fiber and the measured image parameter profile of the reference fiber; and rotating the polarization-maintaining optical fiber to a desired angle relative to the measured image parameter profile of the reference optical fiber based on a maximum value of the correlation. The desired angle may be along the slow axis or the fast axis of the polarization-maintaining optical fiber. The maximum value of the correlation may be found by curve-fitting a parabolic mathematical function to the correlation.

According to another aspect of the present invention, there is provided a method of aligning a first optical fiber with a second optical fiber, the method including illuminating a side of the first optical fiber; rotating the first optical fiber at incremental rotation angles; obtaining a first image profile of the first optical fiber at each rotation angle such that a focal plane of the first image profile is positioned within the first optical fiber; measuring an image parameter of the first optical fiber at each rotation angle based on the respective first image profile; constructing a measured first image parameter profile of the first optical fiber for each rotation angle based on the measured first image parameters; illuminating a side of the second optical fiber; rotating the second optical fiber at incremental rotation angles; obtaining a second image profile of the second optical fiber at each rotation angle such that a focal plane of the second image profile is positioned within the second optical fiber; measuring an image parameter of the second optical fiber at each rotation angle based on the respective second image profile; constructing a measured second image parameter profile of the second optical fiber for each rotation angle based on the measured second image parameters; calculating a correlation between the measured first image parameter profile and the measured second image parameter profile; determining a rotation angle at which the correlation has a maximum value; and rotating the second optical fiber to a desired angle with respect to the first optical fiber based on the maximum value of the correlation. The maximum value of the correlation may be found by curve-fitting a parabolic mathematical function to the correlation. The second optical fiber may be rotated such that a fast axis of the second optical fiber is aligned along the same direction as a fast axis of the first optical fiber. Alternatively, the second optical fiber may be rotated such that a fast axis of the second optical fiber is aligned along the same direction as a slow axis of the first optical fiber. Alternatively, the second optical fiber may be rotated such that a fast axis of the second optical fiber is rotated by 45° with respect to a fast axis of the first optical fiber.

According to another aspect of the present invention, there is provided a method of identifying an unknown optical fiber, the method including (a) illuminating a side of a reference optical fiber; rotating the reference optical fiber at incremental rotation angles; obtaining a reference image profile of the reference optical fiber at each rotation angle such that a focal plane of the reference image profile is positioned within the reference optical fiber; and measuring an image parameter of the reference optical fiber at each rotation angle based on the respective reference image profile; (b) constructing a measured image parameter profile of the reference optical fiber as a function of rotation angle based on the measured image parameters of the reference optical fiber; (c) repeating (a) and (b) for a plurality of reference optical fibers; (d) recording a measured reference image parameter profile for each of the plurality of reference fibers in a matrix; (e) illuminating a side of the unknown optical fiber; rotating the unknown optical fiber at incremental rotation angles; obtaining an unknown image profile of the unknown optical fiber at each rotation angle such that a focal plane of the unknown image profile is positioned within the unknown optical fiber; and measuring an image parameter of the unknown optical fiber at each rotation angle based on the respective unknown image profile; (f) constructing a measured image parameter profile of the unknown optical fiber for each rotation angle based on the measured image parameters; (g) calculating a maximum correlation between the measured image parameter profile of the unknown optical fiber and each of the measured reference image parameter profiles in the matrix; and (h) identifying the unknown optical fiber based on the maximum correlation.

### BRIEF DESCRIPTION OF THE DRAWINGS

The above and other aspects of the present invention will become more apparent by describing in detail exemplary embodiments thereof with reference to the attached drawings in which:

FIG. 1A shows a cross-section of a PANDA fiber;

FIG. 1B shows a cross-section of an elliptical-clad fiber;

FIG. 1C shows a cross-section of a bow-tie fiber;

FIG. 2A shows a cross-section of an elliptic-core fiber produced by modified chemical vapor deposition (MCVD);

FIG. 2B shows a cross-section of an elliptic-core fiber produced by outside vapor deposition (OVD);

FIG. 3A shows the fast and slow axes of a PANDA fiber;

FIG. 3B shows the fast and slow axes of an elliptical-clad fiber;

FIG. 3C shows the fast and slow axes of a bow-tie fiber;

FIG. 3D shows the fast and slow axes of an elliptical-core fiber;

FIG. 4 shows the angle between the slow axes of two elliptical-clad polarization-maintaining optical fibers;

FIG. 5 shows a related art manual method of aligning two polarization-maintaining optical fibers;

FIG. 6 shows another related art method of aligning two polarization-maintaining optical fibers by using polarization observation by the lens effect (POL);

FIG. 7 shows an image recorded by the POL method;

FIG. 8 shows another example of the POL method when the fiber shown in FIG. 6 is rotated by 90°;

FIG. 9A shows a POL contrast profile measured for a bow-tie fiber;

FIG. 9B shows a POL contrast profile measured for a PANDA fiber;

FIG. 9C shows a POL contrast profile measured for an elliptical-clad fiber;

FIG. 10 shows another related art method of aligning two polarization-maintaining optical fibers by the Profile Alignment System (PAS);

FIG. 11 shows another related art method of aligning two polarization-maintaining optical fibers by the end view method;

FIG. 12 shows image profiles of ends of two polarization-maintaining optical fibers;

FIG. 13 shows image parameters that can be defined and measured within the image profiles shown in FIG. 12 in accordance with an exemplary embodiment of the present invention;

FIG. 14A shows a graph of various image parameters that are measured as a function of rotation angle in accordance with an exemplary embodiment of the present invention;

FIG. 14B shows a graph of additional image parameters that are measured as a function of rotation angle in accordance with an exemplary embodiment of the present invention;

FIG. 15 shows a graph of a measured image parameter profile and an approximated image parameter profile that is constructed by curve-fitting the measured image parameter profile in accordance with an exemplary embodiment of the present invention;

FIG. 16 shows the correlation between a measured image parameter profile and the approximated image parameter profile shown in FIG. 15;

FIG. 17 shows the aligning angle between two measured image parameter profiles in accordance with an exemplary embodiment of the present invention;

FIG. 18 shows the correlation between the measured image parameter profiles shown in FIG. 17;

FIG. 19 shows an example of an image parameter profile that is stored in a matrix; and

FIG. 20 shows an example of the angular relationship between a reference image parameter profile that has the strongest correlation with a first optical fiber and the reference image parameter profile that has the strongest correlation with a second optical fiber.

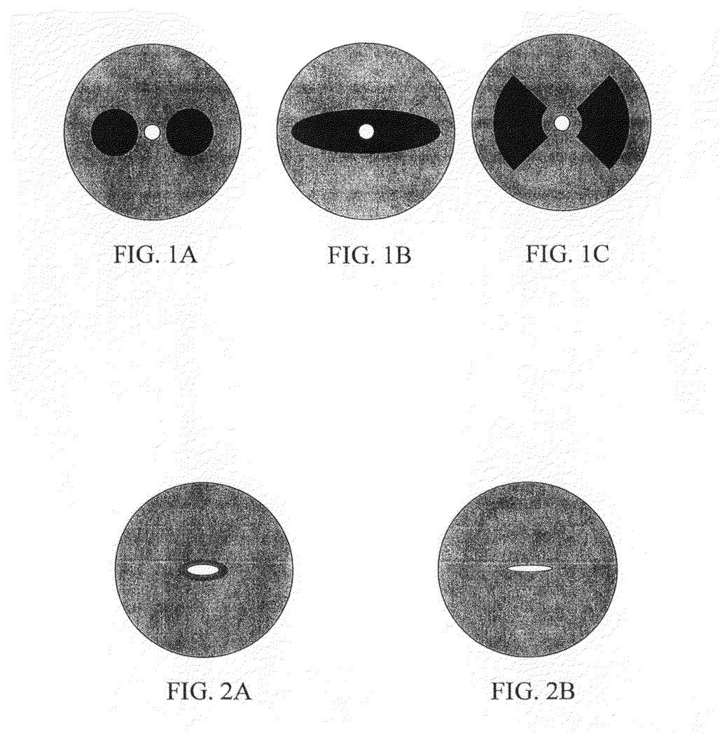

### DETAILED DESCRIPTION OF EXEMPLARY EMBODIMENTS OF THE INVENTION

The present invention will now be described more fully with reference to the accompanying drawings, in which exemplary embodiments of the invention are shown. These embodiments are provided so that this disclosure will be thorough and complete, and will fully convey the concept of the invention to those skilled in the art. However, the invention may be embodied in many different forms, and should not be construed as being limited to the exemplary embodiments set forth herein. In the drawings, like reference numerals denote like elements, and the thicknesses of layers and regions may be exaggerated for clarity and convenience.

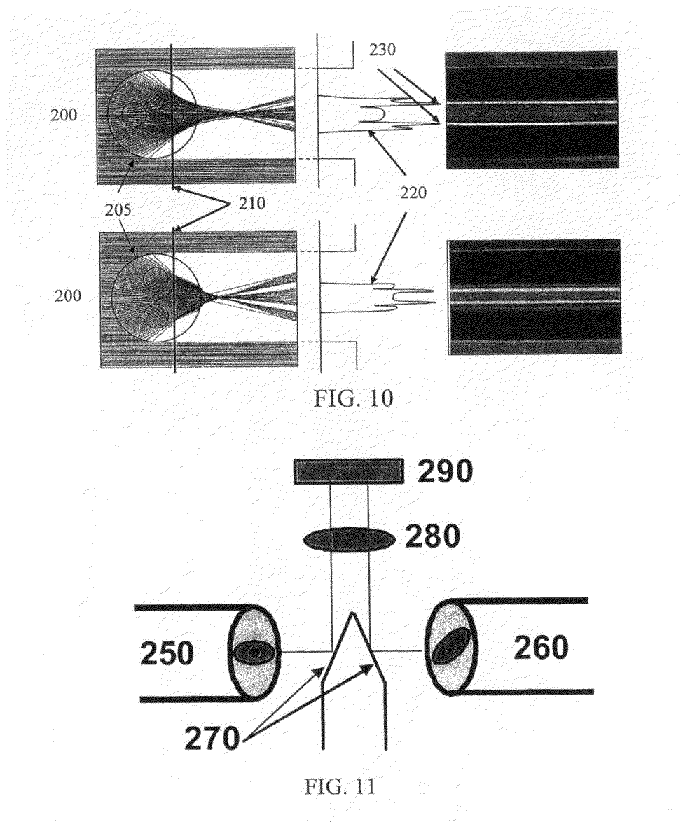

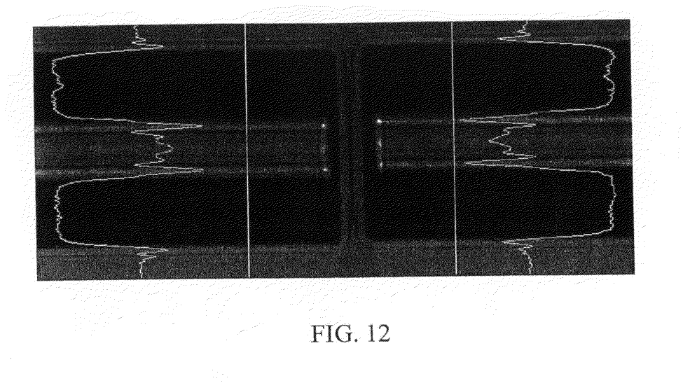

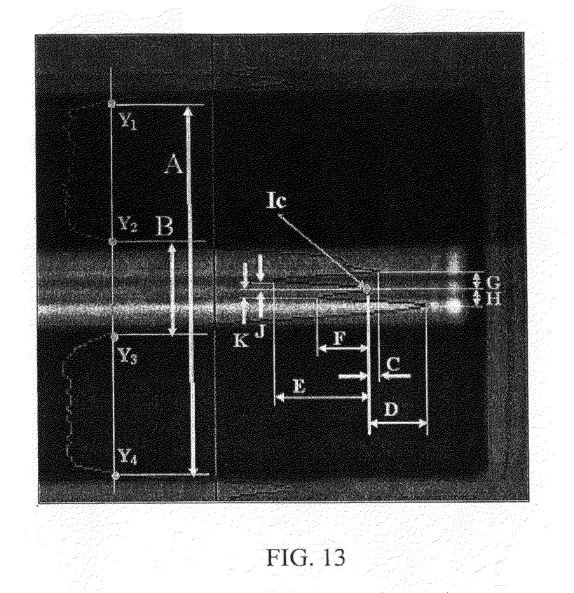

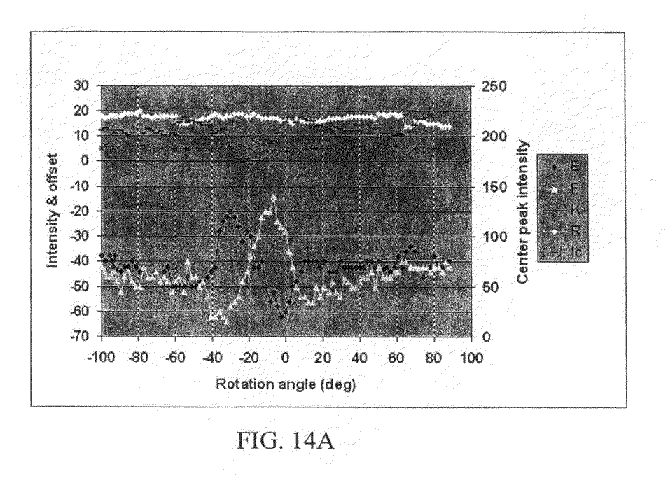

According to an exemplary embodiment of the present invention, a method for aligning a polarization-maintaining optical fiber is provided. FIG. 12 shows image profiles of ends of two polarization-maintaining optical fibers. Each of the image profiles is acquired by using the method shown in FIG. 10, in which collimated light is incident on the side of the polarization-maintaining optical fiber (205) and the focal plane (210) is positioned within the polarization-maintaining optical fiber (205). In FIG. 12 a low light intensity is indicated by a dark area, while a high light intensity is indicated by a bright area. These image profiles have a great deal of detail, and several characteristics and features may be observed within the bright center area. In this respect, the image profiles shown in FIG. 12 present more features for observation and analysis than the POL method, in which the focal plane is positioned outside of the polarization-maintaining optical fiber. The image profile of a polarization-maintaining optical fiber depends upon the structure of the inside of the polarization-maintaining optical fiber, the position of the focal plane, and the rotational orientation of the fiber relative to the observation axis. A graph of the intensity of the light is superimposed on each image profile in FIG. 12. In FIG. 12 the vertical line on each fiber image shows an example location where the brightness intensity is measured.

FIG. 13 illustrates various image parameters that can be defined and measured within an image profile of a polarization-maintaining optical fiber according to an exemplary embodiment of the present invention. As shown in FIG. 13, A=|Y₁−Y₄| is the diameter of the cladding, B=|Y₂−Y₃| is the width of the bright area, C is the upper ridge intensity difference, D is the lower ridge intensity difference, E is the upper valley intensity difference, F is the lower valley intensity difference, G is the upper ridge position difference, H is the lower ridge position difference, J is the upper valley position difference, K is the lower valley position difference, and I_{c} is the central peak intensity. These image parameters can be used to calculate additional image parameters, such as the fiber center C_{f}=(Y₁+Y₄)/2, the bright area center C_{b}=(Y₂+Y₃)/2, the focus ratio R=B/A, and the offset S=C_{f}−C_{b} between the fiber center C_{f} and the bright area center C_{b}. Depending upon the specific type of polarization-maintaining optical fiber and the focus position, there may be more or fewer features, or different features that may be observed as compared to this example.

In an exemplary embodiment of the present invention, a polarization-maintaining optical fiber is rotated while an image sensor automatically acquires image profiles of the end of the polarization-maintaining optical fiber at incremental rotation angles, such as every 3°. As discussed above, the image profiles are acquired as shown in FIG. 10 in which the focal plane (210) is positioned within the polarization-maintaining optical fiber. The polarization-maintaining optical fiber may be rotated through 360°, or by a smaller amount, such as from −100° to 100°. A microprocessor uses the image profiles to measure at least one of the image parameters described above at each rotation angle. The microprocessor then constructs a measured image parameter profile as a function of rotation angle based on one of the measured image parameters.

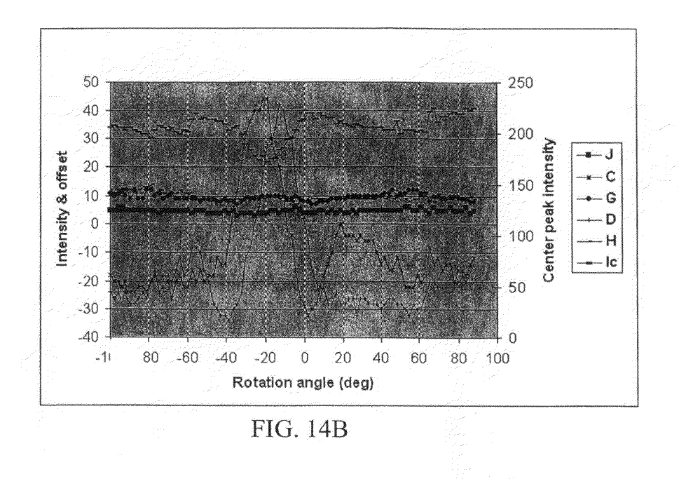

FIGS. 14A and 14B show examples of measured image parameter profiles for an elliptical-core polarization-maintaining optical fiber. As shown in FIGS. 14A and 14B, the upper ridge intensity difference (C), the lower ridge intensity difference (D), the upper valley intensity difference (E), the lower valley intensity difference (F), and the central peak intensity (I_{c}) vary significantly over the measured range of rotation angles. Therefore, one of these image parameter profiles may preferably be used to align the polarization-maintaining optical fiber.

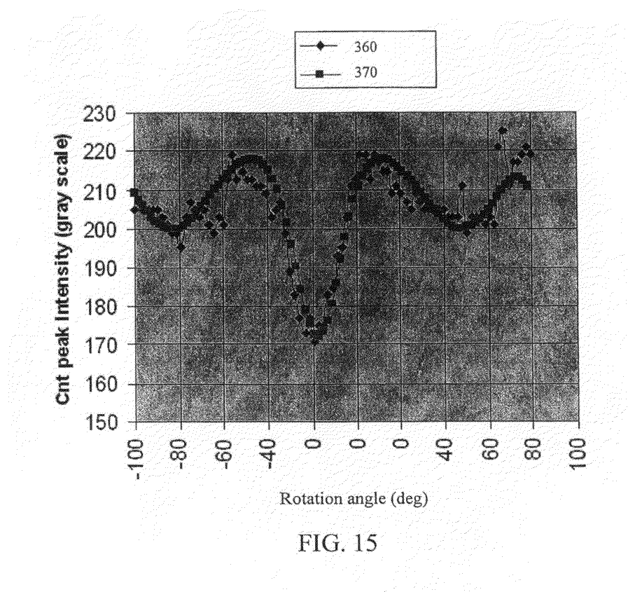

In an exemplary embodiment of the present invention, an approximated image parameter profile may be constructed by curve-fitting a mathematical function to the measured image parameter profile. FIG. 15 shows an example in which an approximated image parameter profile (370) is constructed by curve-fitting a truncated Fourier series to a measured image parameter profile (360). In this example the measured image parameter profile (360) is the central peak intensity (I_{c}) that is illustrated in FIG. 13. The approximated image parameter profile (370) eliminates the noise and the focus plane variation in the measured image parameter profile (360). Also, the approximated image parameter profile (370) is continuous over the measured range of rotation angles, whereas the measured image parameter profile (360) includes only data points measured at incremental rotation angles. Therefore, the approximated image parameter profile (370) can be used to simulate the image parameter at any rotation angle.

The approximated image parameter profile can be used to select a desired rotation angle for the polarization-maintaining optical fiber. For example, the shape of the approximated image parameter profile may indicate the rotation angles of the slow and fast axes of the polarization-maintaining optical fiber. Based on this information, the polarization-maintaining optical fiber can be rotated to be aligned at any desired rotation angle, such as along the slow or the fast axis, or at an angle with respect to the slow or the fast axis.

If no feature of the image parameter profile indicates the rotational location of the slow or fast axis of the polarization-maintaining optical fiber, the positions of the slow and fast axes along the image parameter profile may be determined by one of several alternative methods. One method is to utilize the related art PAS system to rotate the polarization-maintaining optical fiber until the PAS system optical axis is aligned to the fast or slow axis of the polarization-maintaining optical fiber, thereby identifying the fast or slow axis position on the image parameter profile.

If the PAS system observation cannot discern the locations of the slow and fast axes of a polarization-maintaining optical fiber, it is possible to use a reference fiber in order to accomplish this task. In this case a reference fiber must be selected that can be aligned by the PAS system. This reference fiber may be a different type from the polarization-maintaining optical fiber so as to be capable of being aligned by the PAS system. The reference fiber is first rotated to the fast and slow axes observation point by the PAS method. The polarization-maintaining optical fiber is then rotated relative to the reference fiber. During this rotation, a PER test method such as that shown in FIG. 5 is used to determine the rotational position at which the slow axis of the polarization-maintaining optical fiber is aligned to the slow axis of the reference fiber. That rotational position is then established as the slow axis position along the polarization-maintaining optical fiber's image parameter profile.

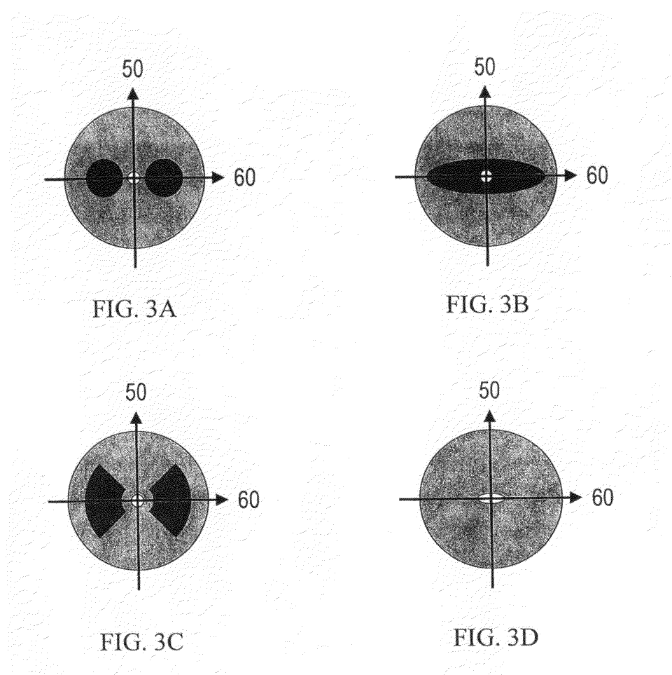

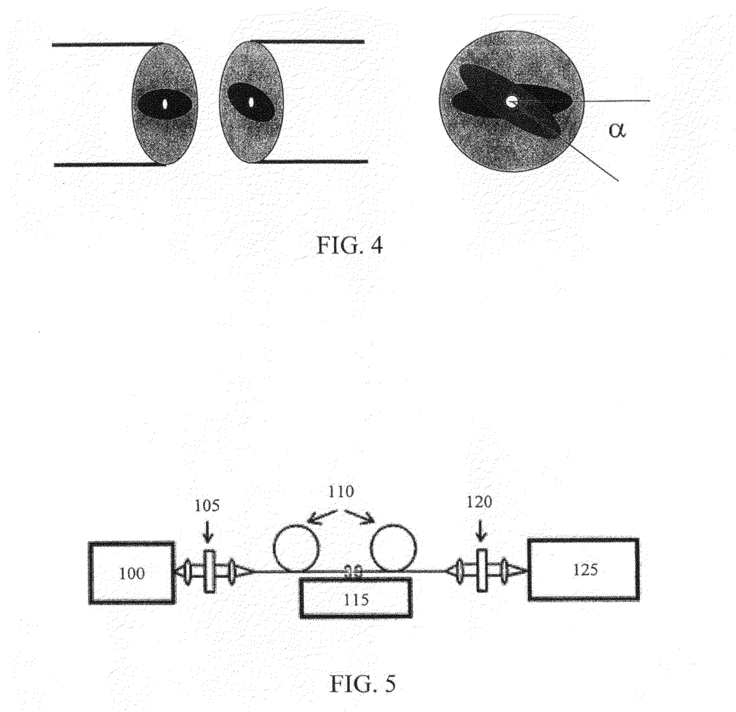

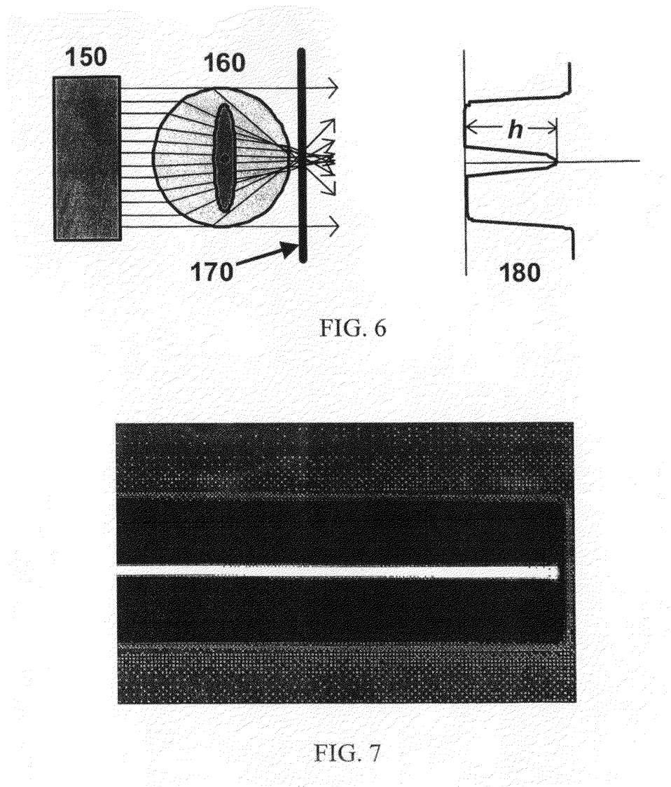

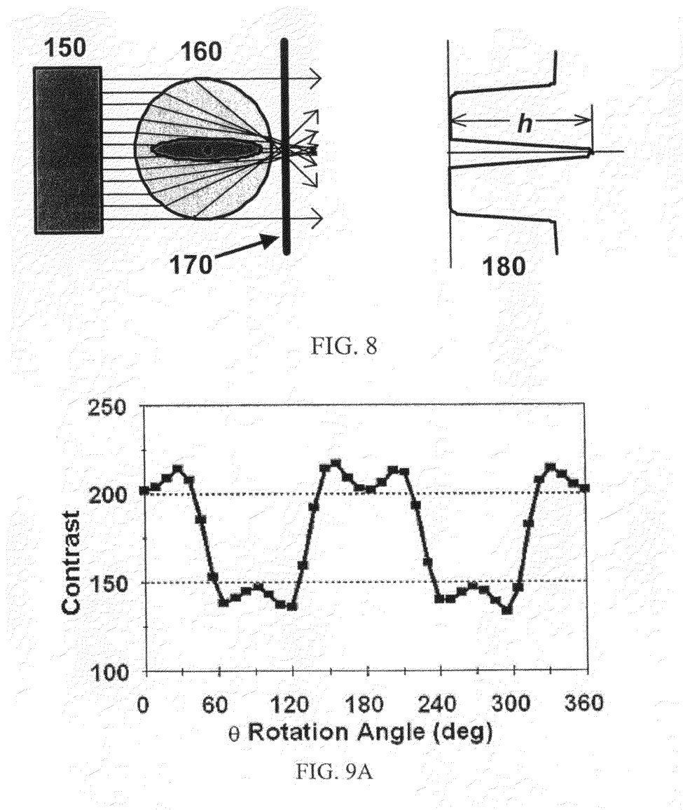

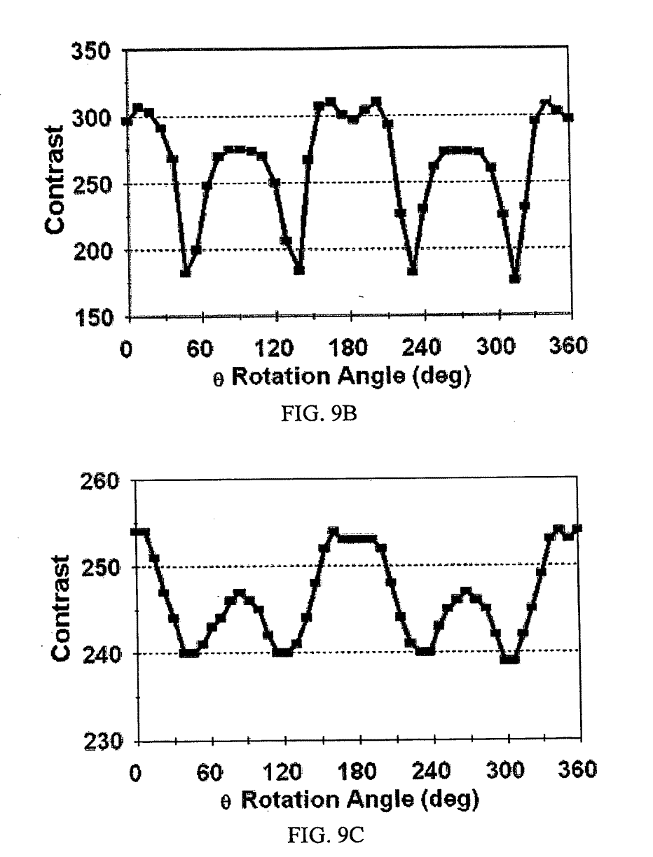

Another method to determine the position of the fast and slow axes of a polarization-maintaining optical fiber is to correlate observation of the fiber end view to that of the image parameter profile. In this case, a splicer or observation system must be utilized that is capable of simultaneously observing both the end view image as well as the side view image of the fiber. In this case, the fast and slow axes of any particular polarization-maintaining optical fiber as shown in FIGS. 3A-3D are immediately correlated with the image parameter profile.

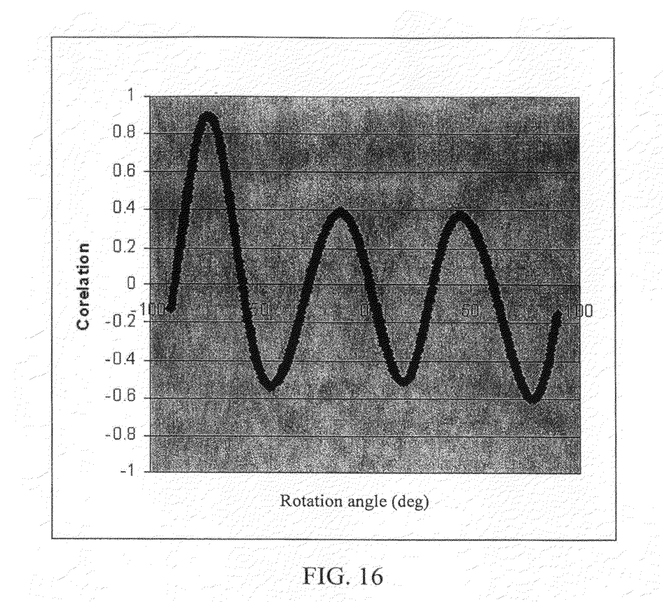

In an exemplary embodiment of the present invention, a reference optical fiber can be used to align a polarization-maintaining optical fiber. In this exemplary embodiment, the reference optical fiber is used to construct an approximated image profile (370) as described above. A measured image profile (360) is then obtained for the polarization-maintaining optical fiber as described above, and a correlation is calculated between the measured image parameter profile (360) and the approximated image parameter profile (370). As shown in FIG. 16, this calculation results in a correlation curve over the measured range of rotation angles. The peak location of the correlation curve indicates the angle offset of the polarization-maintaining optical fiber in the splicer from the reference fiber. The polarization-maintaining optical fiber can then be aligned to any desired angle by rotating the polarization-maintaining optical fiber based on the angle offset, and is then fixed in the splicer at this rotation angle. According to this method, the approximated image parameter profile can serve as a reference for any subsequent polarization-maintaining optical fiber of the same type. Alternatively, the measured image parameter profile (360) of the polarization-maintaining optical fiber can be correlated with the measured image parameter profile of the reference fiber. In this case it would be unnecessary to construct the approximated image parameter profile for the reference fiber.

In another exemplary embodiment of the present invention, at least one measured image parameter profile from a reference polarization-maintaining optical fiber can be recorded in an array or a matrix to align subsequent polarization-maintaining optical fibers. In this exemplary embodiment, the reference polarization-maintaining optical fiber is rotated while an image sensor automatically acquires image profiles of the end of the reference polarization-maintaining optical fiber at incremental rotation angles, as described above. A measured image parameter profile f(t) is constructed based on one of the measured image parameters as a function of rotation angle. The measured image parameter profile f(t) is then recorded in an array. Additional measured image parameter profiles may also be constructed and recorded in a matrix, along with the first measured image parameter profile f(t). A measured image parameter profile g(t) is then obtained for a subsequent polarization-maintaining optical fiber to be aligned by the method described above.

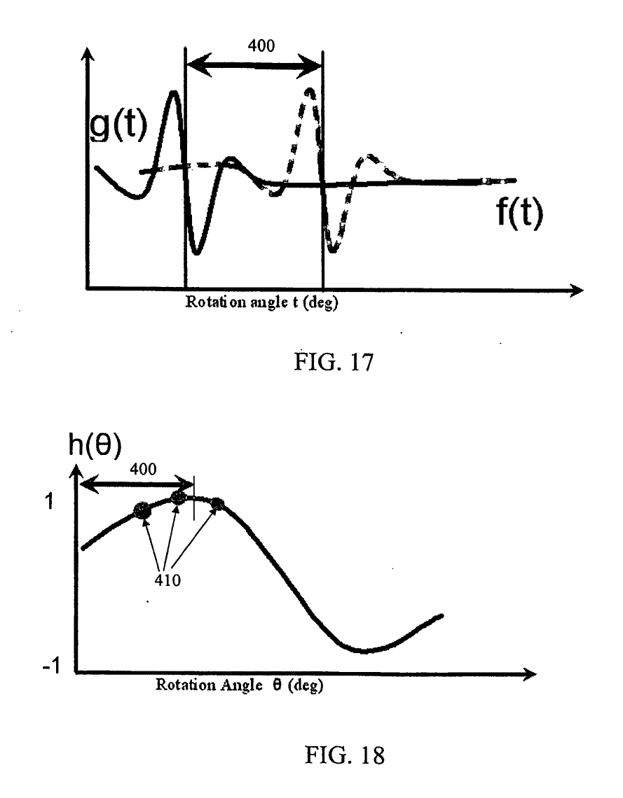

FIG. 17 shows the aligning angle (400) between the measured image parameter profile f(t) and the measured image parameter profile g(t). The aligning angle (400) is determined by calculating the correlation between the measured image parameter profile f(t) and the measured image parameter profile g(t). The correlation h(θ) may be calculated by Equation (1) below:

$$h ( θ ) = \frac{{\sum }_{t} ( f ( t - θ ) - \overline{f ( t - θ )} ) ( g ( t ) - \overline{g ( t )} )}{\sqrt{{\sum }_{t} {( f ( t - θ ) - \overline{f ( t - θ )} )}^{2}} \sqrt{{\sum }_{t} {( g ( t ) - \overline{g ( t )} )}^{2}}} . \qquad ( 1 )$$

An example of the correlation h(θ) is shown in FIG. 18. The aligning angle (400) is at the peak of the correlation h(θ), which is found between two measured data points (410). Therefore, the peak may be found by performing a parabolic curve-fitting to the correlation h(θ). The parabolic curve-fitting allows the aligning angle (400) to be found even if it lies between two measured data points (410). The subsequent polarization-maintaining optical fiber may then be fixed at the aligning angle (400).

In another exemplary embodiment of the present invention, reference arrays or matrices can be recorded for different types of polarization-maintaining optical fibers, and these reference arrays or matrices can be used to align dissimilar polarization-maintaining optical fiber types. For example, a first matrix of image parameter profiles can be recorded for a reference PANDA fiber, and a second matrix of image parameter profiles can be recorded for a reference bow-tie fiber. A PANDA fiber can then be aligned with a bow-tie fiber by calculating the correlation of an image parameter profile of the PANDA fiber with the corresponding image parameter profile in the first (PANDA) matrix, and calculating the correlation of an image parameter profile of the bow-tie fiber with the corresponding image parameter profile in the second (bow-tie) matrix.

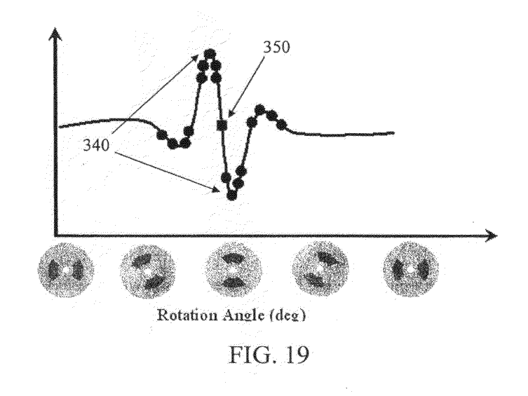

Since the matrices for the PANDA and the bow-tie fibers may be quite different, it may be necessary to employ a method to correlate the matrices for the different fiber types. This can be accomplished by selecting a distinct Alignment Point in the image parameter profile for each fiber. The distinct Alignment Point for each profile may be selected such that the fiber can be easily rotated to that point in the camera field of view with great accuracy and repeatability. FIG. 19 shows an example image parameter profile from an example matrix. An inflection point such as the point (350) shown in FIG. 19 may be used as a distinct Alignment Point. In this example the inflection point (350) occurs where the slope reaches a maximum value, and that inflection point lies between local maximum and minimum points (340). Rotational alignment of a fiber to such an point will provide accuracy and repeatability. The distinct Alignment Point for one or both fiber types may correspond to the fast or slow axis of the fiber, or to another axis of the fiber. In addition, aligning the PANDA fiber and the bow-tie fiber to their respective selected distinct Alignment Points (with respect to the observation camera) may not align the polarization axes of the two fibers to each other. This issue may be overcome by test and observation to determine the angular position of each fibers distinct Alignment Point relative to that fiber's polarization axis (typically to the slow axis). This will allow an individual correction angle to be applied to each fiber. Alternatively, a PER measurement system such as that shown in FIG. 5 may be employed to determine the relative angular offset of the two fibers when each is aligned to its distinct Alignment Point. In this latter case, a single angular correction may be employed to correct the relative angle between that particular fiber pair.

In an exemplary embodiment of the present invention, the matrices for two different polarization-maintaining optical fiber types may be related to each other by relating the determined positions of the fast and slow axes for each polarization-maintaining optical fiber on their respective image parameter profiles. One method to overlay the positions of the fast and slow axes on each image parameter profile for a specific polarization-maintaining optical fiber may be to reference and correlate the image parameter profile to the PAS alignment point for the fast and slow axes of that fiber. Another method may be to use the PAS fast and slow axes of a reference fiber and correlate that it to the image parameter profiles within the matrix of a particular polarization-maintaining optical fiber by using a PER test system as shown in FIG. 5. Another method is to use an end view system as shown in FIG. 11 to make a direct correlation between the image parameter profiles within a matrix to the fiber end image. If the positions of the fast and slow axes are established along each image parameter profile, the different image parameter profiles for dissimilar combinations of polarization-maintaining optical fiber are easily related and the fibers can be aligned to each other at and desired angle with great accuracy.

In another exemplary embodiment of the present invention, a first polarization-maintaining optical fiber can be aligned with a second polarization-maintaining optical fiber of the same type without using previously acquired reference data. A measured image parameter profile f(t) of the first polarization-maintaining optical fiber is acquired as discussed above. A measured image parameter profile g(t) of the second polarization-maintaining optical fiber is also acquired as discussed above, such that the measured image parameter profile g(t) tracks the same image parameter as the measured image parameter profile f(t). The correlation h(θ) between the measured image parameter profiles f(t) and g(t) is calculated by Equation (1), and the second polarization-maintaining optical fiber is rotated to match the orientation of the first polarization-maintaining optical fiber based on the aligning angle (400) obtained from the correlation h(θ).

In another exemplary embodiment of the present invention, an unknown type of polarization-maintaining optical fiber can be identified. In this exemplary embodiment a reference array or matrix of measured image parameter profiles f(t) is recorded for each of a plurality of polarization-maintaining optical fiber types. A measured image parameter profile g(t) of the unknown polarization-maintaining optical fiber is acquired as discussed above. The correlation h(θ) between the measured image parameter profile g(t) of the unknown polarization-maintaining optical fiber and the reference image parameter profile f(t) is calculated by Equation (1) for each fiber type. The unknown polarization-maintaining optical fiber is identified as being the same type as the reference polarization-maintaining optical fiber with which the unknown polarization-maintaining optical fiber has the strongest correlation h(θ).

The methods embodied above may be employed for the purposes of aligning similar or dissimilar combinations of polarization-maintaining optical fibers as discussed above. The same methods and calculations may also be used to confirm or measure the alignment before or after splicing. In an exemplary embodiment of the present invention, the angular misalignment of two polarization-maintaining optical fibers of the same type that have previously been aligned or spliced may be determined by rotating the fibers simultaneously and in unison. As the two fibers are rotated, a measured image parameter profile f(t) is constructed for the first fiber and a measured image parameter profile g(t) is constructed for the second fiber as discussed above. The misalignment of the two fibers is then determined by using Equation (1) to calculate the correlation h(θ) between f(t) and g(t). In this case, the angular misalignment between the two fibers is defined as shown in FIG. 17 by the feature previously designated as the aligning angle (400) as discussed above in the case of using f(t) and g(t) for the purposes of fiber alignment.

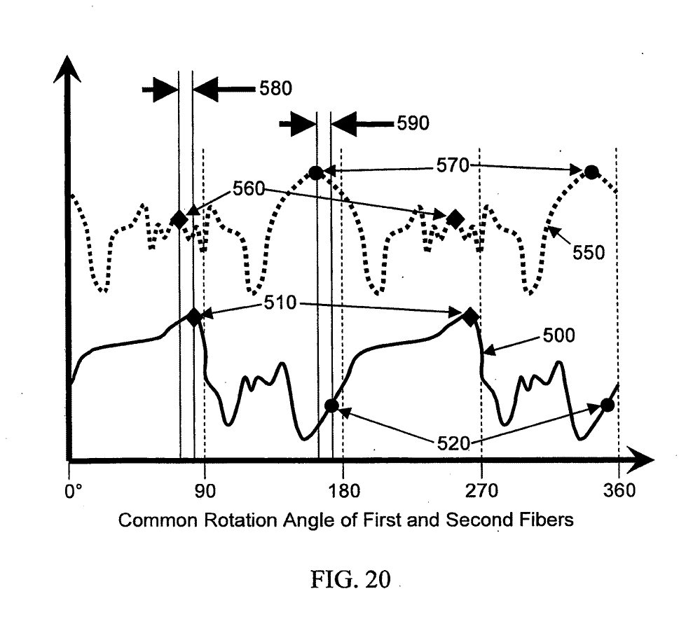

In a further exemplary embodiment of the present invention, the angular misalignment of two polarization-maintaining optical fibers of different types that have previously been aligned or spliced may be determined by rotating the fibers simultaneously and in unison. In this case, matrices of image parameter profiles have already been constructed for different types of reference polarization maintaining fibers. The position of the slow or fast axis has been determined for each reference fiber along each image parameter profile as discussed above. As the two different polarization maintaining optical fibers are rotated simultaneously in unison, a measured image parameter profile f(t) is constructed for the first fiber and a measured image parameter profile g(t) is constructed for the second fiber as discussed above. The measured image parameter profiles of the two fibers can then be correlated with all available reference image parameter profiles in each matrix for every reference polarization-maintaining optical fiber type. The correlation h(θ) for the first fiber with each reference image parameter profile is calculated using Equation (1). The first fiber is identified as being the same type as the reference polarization maintaining optical fiber which has the strongest correlation h(θ) to f(t). Similarly, the correlation h(θ) for the second fiber with each reference image parameter profile is calculated using Equation (1). The second fiber is identified as being the same type as the reference polarization-maintaining optical fiber which has the strongest correlation h(θ) to g(t). Since the first and second fibers were rotated simultaneously and in unison, the angular relationship between f(t) and g(t) is known. Therefore the angular relationship between the corresponding reference image parameter profile with the strongest correlation h(θ) to f(t) for the first fiber and the reference image profile with the strongest correlation h(θ) to g(t) for the second fiber is also known. FIG. 20 shows an example angular rotational relationship between the reference image parameter profile (500) which has the strongest correlation h(θ) to f(t) for the first fiber and the reference image profile (550) which has the strongest correlation h(θ) to g(t) for the second fiber. Both reference image parameter profiles are plotted relative to the common rotation angle established by the simultaneous rotation of the first and second fibers in unison. Since the locations of the slow axis position (510) and fast axis position (520) for the first reference image parameter profile (500) are known, they are shown on the first reference image parameter profile (500). Similarly, since the locations of the slow axis position (560) and fast axis position (570) for the second reference image parameter profile (550) are known, they are shown on the second reference image parameter profile (550). The angular misalignment of the first and second polarization-maintaining optical fibers is determined from the relative angular position of the slow axis (510) of the first reference image parameter profile (500) versus the angular position of the slow axis (560) of the second reference image parameter profile (550). The angular misalignment of the first versus the second fiber is calculated to be the angular misalignment (580) of the two slow axis positions. As an alternative, the angular misalignment of the first versus the second fiber may be calculated to be the angular misalignment (590) of the two slow axis positions.

In a further exemplary embodiment of the present invention, the angular misalignment between two polarization-maintaining optical fibers of the same type or of different types as calculated above may be used to directly calculate the polarization cross talk between the two fibers. In addition, the resulting PER can be calculated if the beginning (pre-splice) PER of the system was known or can be estimated. This information can be displayed or presented graphically. The estimation of the angular misalignment, polarization cross talk, or PER can also be recorded for process control.

While the present invention has been particularly shown and described with reference to exemplary embodiments thereof, it will be understood by those of ordinary skill in the art that various changes in form and detail may be made therein without departing from the spirit and scope of the present invention as defined by the following claims and their legal equivalents.

What is claimed is:

1. A method of analyzing a polarization-maintaining optical fiber, the method comprising:
illuminating a side of the optical fiber;
rotating the optical fiber at incremental rotation angles;
obtaining an image profile of the optical fiber at each rotation angle such that a focal plane of the image profile is positioned within the optical fiber;
measuring an image parameter at each rotation angle based on the respective image profile; and
constructing a measured image parameter profile of the optical fiber as a function of rotation angle based on the measured image parameters.

2. The method according to claim 1, further comprising constructing an approximated image parameter profile of the optical fiber as a function of rotation angle by curve-fitting a mathematical function to the measured image parameter profile.

3. The method according to claim 2, wherein the image parameter is an upper ridge intensity difference, a lower ridge intensity difference, an upper valley intensity difference, a lower valley intensity difference, or a central peak intensity.

4. The method according to claim 2, wherein the mathematical function is a truncated Fourier series.

5. The method according to claim 2, further comprising selecting a desired rotation angle based on the approximated image parameter profile.

6. The method according to claim 5, further comprising rotating the optical fiber to the desired rotation angle.

7. The method according to claim 6, wherein the desired rotation angle is along the slow axis or the fast axis of the optical fiber.

8. A method of aligning a polarization-maintaining optical fiber, the method comprising:
illuminating a side of a reference optical fiber;
rotating the reference optical fiber at incremental rotation angles;
obtaining a reference image profile of the reference optical fiber at each rotation angle such that a focal plane of the reference image profile is positioned within the reference optical fiber;
measuring an image parameter of the reference optical fiber at each rotation angle based on the respective reference image profile;
constructing a measured image parameter profile of the reference optical fiber as a function of rotation angle based on the measured image parameters of the reference optical fiber;
constructing an approximated image parameter profile of the reference optical fiber as a function of rotation angle by curve-fitting a mathematical function to the measured image parameter profile of the reference optical fiber;
illuminating a side of the polarization-maintaining optical fiber;
rotating the polarization-maintaining optical fiber at incremental rotation angles;
obtaining an image profile of the polarization-maintaining optical fiber at each rotation angle such that a focal plane of the polarization-maintaining image profile is positioned within the polarization-maintaining optical fiber;
measuring an image parameter of the polarization-maintaining optical fiber at each rotation angle based on the respective polarization-maintaining image profile;
constructing a measured image parameter profile of the polarization-maintaining optical fiber as a function of rotation angle based on the measured image parameters of the polarization-maintaining optical fiber;
calculating a correlation between the measured image parameter profile of the polarization-maintaining optical fiber and the approximated image parameter profile of the reference fiber; and
rotating the polarization-maintaining optical fiber to a desired angle relative to the approximated image parameter profile of the reference optical fiber based on a maximum value of the correlation.

9. The method according to claim 8, wherein the desired angle is along the slow axis or the fast axis of the polarization-maintaining optical fiber.

10. A method of aligning a polarization-maintaining optical fiber, the method comprising:
illuminating a side of a reference optical fiber;
rotating the reference optical fiber at incremental rotation angles;
obtaining a reference image profile of the reference optical fiber at each rotation angle such that a focal plane of the reference image profile is positioned within the reference optical fiber;
measuring an image parameter of the reference optical fiber at each rotation angle based on the respective reference image profile;
constructing a measured image parameter profile of the reference optical fiber as a function of rotation angle based on the measured image parameters of the reference optical fiber;
illuminating a side of the polarization-maintaining optical fiber;
rotating the polarization-maintaining optical fiber at incremental rotation angles;
obtaining an image profile of the polarization-maintaining optical fiber at each rotation angle such that a focal plane of the polarization-maintaining image profile is positioned within the polarization-maintaining optical fiber;
measuring an image parameter of the polarization-maintaining optical fiber at each rotation angle based on the respective polarization-maintaining image profile;
constructing a measured image parameter profile of the polarization-maintaining optical fiber as a function of rotation angle based on the measured image parameters of the polarization-maintaining optical fiber;
calculating a correlation between the measured image parameter profile of the polarization-maintaining optical fiber and the measured image parameter profile of the reference fiber; and
rotating the polarization-maintaining optical fiber to a desired angle relative to the measured image parameter profile of the reference optical fiber based on a maximum value of the correlation.

11. The method according to claim 10, wherein the desired angle is along the slow axis or the fast axis of the polarization-maintaining optical fiber.

12. The method according to claim 10, wherein the maximum value of the correlation is found by curve-fitting a parabolic mathematical function to the correlation.

13. A method of aligning a first optical fiber with a second optical fiber, the method comprising:
illuminating a side of the first optical fiber;
rotating the first optical fiber at incremental rotation angles;
obtaining a first image profile of the first optical fiber at each rotation angle such that a focal plane of the first image profile is positioned within the first optical fiber;
measuring an image parameter of the first optical fiber at each rotation angle based on the respective first image profile;
constructing a measured first image parameter profile of the first optical fiber for each rotation angle based on the measured first image parameters;
illuminating a side of the second optical fiber;
rotating the second optical fiber at incremental rotation angles;
obtaining a second image profile of the second optical fiber at each rotation angle such that a focal plane of the second image profile is positioned within the second optical fiber;
measuring an image parameter of the second optical fiber at each rotation angle based on the respective second image profile;
constructing a measured second image parameter profile of the second optical fiber for each rotation angle based on the measured second image parameters;
calculating a correlation between the measured first image parameter profile and the measured second image parameter profile;
determining a rotation angle at which the correlation has a maximum value; and
rotating the second optical fiber to a desired angle with respect to the first optical fiber based on the maximum value of the correlation.

14. The method according to claim 13, wherein the maximum value of the correlation is found by curve-fitting a parabolic mathematical function to the correlation.

15. The method according to claim 13, wherein the second optical fiber is rotated such that a fast axis of the second optical fiber is aligned along the same direction as a fast axis of the first optical fiber.

16. The method according to claim 13, wherein the second optical fiber is rotated such that a fast axis of the second optical fiber is aligned along the same direction as a slow axis of the first optical fiber.

17. The method according to claim 13, wherein the second optical fiber is rotated such that a fast axis of the second optical fiber is rotated by 45° with respect to a fast axis of the first optical fiber.

18. A method of identifying an unknown optical fiber, the method comprising:
(a) illuminating a side of a reference optical fiber; rotating the reference optical fiber at incremental rotation angles; obtaining a reference image profile of the reference optical fiber at each rotation angle such that a focal plane of the reference image profile is positioned within the reference optical fiber; and measuring an image parameter of the reference optical fiber at each rotation angle based on the respective reference image profile;
(b) constructing a measured image parameter profile of the reference optical fiber as a function of rotation angle based on the measured image parameters of the reference optical fiber;
(c) repeating (a) and (b) for a plurality of reference optical fibers;
(d) recording a measured reference image parameter profile for each of the plurality of reference fibers in a matrix;
(e) illuminating a side of the unknown optical fiber; rotating the unknown optical fiber at incremental rotation angles; obtaining an unknown image profile of the unknown optical fiber at each rotation angle such that a focal plane of the unknown image profile is positioned within the unknown optical fiber; and measuring an image parameter of the unknown optical fiber at each rotation angle based on the respective unknown image profile;
(f) constructing a measured image parameter profile of the unknown optical fiber for each rotation angle based on the measured image parameters;
(g) calculating a maximum correlation between the measured image parameter profile of the unknown optical fiber and each of the measured reference image parameter profiles in the matrix; and
(h) identifying the unknown optical fiber based on the maximum correlation.

19. A method of aligning an unknown optical fiber, the method comprising:
(a) illuminating a side of a reference optical fiber; rotating the reference optical fiber at incremental rotation angles; obtaining a reference image profile of the reference optical fiber at each rotation angle such that a focal plane of the reference image profile is positioned within the reference optical fiber; and measuring an image parameter of the reference optical fiber at each rotation angle based on the respective reference image profile;
(b) constructing a measured image parameter profile of the reference optical fiber as a function of rotation angle based on the measured image parameters of the reference optical fiber;
(c) repeating (a) and (b) for a plurality of reference optical fibers;
(d) recording a measured reference image parameter profile for each of the plurality of reference fibers in a matrix;
(e) illuminating a side of the unknown optical fiber; rotating the unknown optical fiber at incremental rotation angles; obtaining an unknown image profile of the unknown optical fiber at each rotation angle such that a focal plane of the unknown image profile is positioned within the unknown optical fiber; and measuring an image parameter of the unknown optical fiber at each rotation angle based on the respective unknown image profile;
(f) constructing a measured image parameter profile of the unknown optical fiber for each rotation angle based on the measured image parameters;
(g) calculating a maximum correlation between the measured image parameter profile of the unknown optical fiber and each of the measured reference image parameter profiles in the matrix; and
(h) selecting the reference image parameter profile based on the maximum correlation,
(i) utilizing the selected reference image parameter profile to align the unknown fiber to a desired angle.
